(19) United States
(12) Patent Application Publication
(10) Pub. No.: US 2022/0252468 A1
(43) Pub. Date: Aug. 11, 2022

(54) Differential Scanning Micro-Calorimeter Using an Ultra-Sensitive Photonic Sensor

(71) Applicant: Northeastern University, Boston, MA (US)

(72) Inventors: Gregory J. Kowalski, Beverly, MA (US); Jose-Luis Zuniga-Cerroblanco, Santa Cruz de Juventino Rosas (MX); Timothy Edwin Beck Sanborn, Rye, NH (US)

(21) Appl. No.: 17/650,330

(22) Filed: Feb. 8, 2022

Related U.S. Application Data
(60) Provisional application No. 63/147,324, filed on Feb. 9, 2021.

(51) Int. Cl. G01K 17/00; G01N 25/48

(52) U.S. Cl. CPC G01K 17/006; G01N 25/4873

(57) ABSTRACT

A method for calorimetry includes providing a sample to a test chamber and applying heat to the test chamber with the sample provided therein, the heat being applied at a known heat rate. In a synchronized manner with respect to applying heat to the test chamber, transmission of light through plural Nano Hole Array (NHA) sensors coupled to the test chamber is measured to obtain a series of extraordinary optical transmission (EOT) measurements. A calorimetry measurement is calculated as a function of the heat rate and the series of EOT measurements, the calorimetry measurement being indicative of energy released as a result of the sample undergoing a change during the application of heat to the test chamber. Samples, including fluids and solids, can be transferred into the test chamber by a pump or other suitable means. Example test chambers include a microchannel injection cell and a co-flow reactor microchannel.

### RELATED APPLICATIONS

This application claims the benefit of U.S. Provisional Application No. 63/147,324, filed on Feb. 9, 2021. The entire teachings of the above application are incorporated herein by reference.

### BACKGROUND

calorimetry involves measuring energy released or absorbed by a reaction over a range of reactant concentrations, and determining the thermodynamic properties, stoichiometry, and equilibrium binding constant for the reaction from the measured transfer of energy.

Techniques of calorimetry are particularly advantageous for studying the thermodynamics of various interactions in matter. Such interactions include binding interactions at a molecular level. Examples of such binding interactions include protein-protein interactions, protein-DNA interactions, and drug-protein interactions of biological and/or pharmaceutical compounds.

Further examples extend outside of the biological realm to include phase changes of matter, such as melting and evaporation. Chemical interactions, occurring at a sub-molecular level, may also be explored by calorimetry.

Temperature sensors conventionally employed for determining the heat of a chemical reaction in calorimetry studies include thermocouples, thermopiles, and/or thermistors. Other temperature sensing methods include sensors with microfluidic channels and have used changes in optical properties to infer temperature changes in reactions.

### SUMMARY

A Photonic Based Differential calorimeter (PBDSC) disclosed herein is a device and associated method that may be used in the early stages of drug discovery and to investigate protein unfolding energy exchanges, denaturing of biological materials, DNA, MRNA, and RNA reactions and/or energy releases in materials due to magnetic or phase changes. The small size of the PBDSC allows it to be multiplexed on a single chip. It uses a photonic sensor to determine a change in extraordinary optical transmission (EOT) through an array of nanoholes to measure temperature (T) and concentration change ([C]) in a sample of interest for a constant pressure (P) process.

A method for calorimetry includes providing a sample to a test chamber and applying heat to the test chamber with the sample provided therein, the heat being applied at a known heat rate. In a synchronized manner with respect to applying heat to the test chamber, transmission of light through plural Nano Hole Array (NHA) sensors coupled to the test chamber is measured to obtain a series of extraordinary optical transmission (EOT) measurements. The method includes calculating a calorimetry measurement as a function of the heat rate and the series of EOT measurements, the calorimetry measurement being indicative of energy released as a result of the sample undergoing a change during the application of heat to the test chamber.

Calculating the calorimetric measurement can include calculating an EOT difference for the NHA sensors over an interval of time, or averaging plural series of EOT measurements to obtain a series of averaged EOT values, or a combination thereof.

The sample being provided in the test chamber can include a fluid or a solid. For example, the sample can include at least two samples, such as a first fluid and a second fluid, or a fluid and a solid.

The method can further include performing an EOT vs. temperature calibration, in which case calculating the calorimetric measurement includes determining a deviation from an expected EOT vs. time relationship, and determining the energy released during the change that the sample undergoes based on (i) the deviation and (ii) a corresponding result of the EOT vs. temperature calibration.

The method can further include performing an EOT vs. temperature calibration and monitoring power dissipated in applying the heat. The calorimetric measurement can be calculated by determining the energy released during the change that the sample undergoes based on (i) the power dissipated in applying the heat and (ii) a corresponding result of the EOT vs. temperature calibration.

The NHA sensors can be integrated upon a substrate of a photonic sensor chip. Each NHA sensor can include an array of holes in an electrically conducting layer, the layer being proximate to and in thermal contact with the test chamber.

In one example, the test chamber includes a microchannel injection cell and the sample includes a first fluid and a second fluid. Providing the sample can include injecting the second fluid into the microchannel injection cell after providing the first fluid to the microchannel injection cell.

In another example, the test chamber includes a co-flow reactor microchannel and the sample includes a first fluid and a second fluid. The method can include flowing the first fluid and the second fluid through the co-flow reactor microchannel, the first fluid flowing through a first inlet and the second fluid flowing through a second inlet. Further, while flowing the first and second fluids and applying heat to the co-flow reactor microchannel, transmission of light through the NHA sensors can be measured to obtain the series of EOT measurements. Flowing the first and seconds fluids can include, for example, using a syringe pump to drive the first fluid from a first syringe coupled to the first inlet and drive the second fluid from a second syringe coupled the second inlet.

Measuring transmission of light through the plural NHA sensors can include irradiating the NHA sensors and the sample(s) in the test chamber with incident light.

Measuring transmission of light can include capturing, and storing in memory, video data for a view of the NHA sensors. Further, if the stored video data includes color video data, the method can include converting the color video data to black and white video data and identifying bright spots, corresponding to individual NHA sensors, represented in the stored video data.

Bright spots in the video data can be identified, for example, by comparing, with a brightness threshold value, brightness information corresponding to pixels represented within the stored video data and determining locations within the view where the brightness information exceeds the threshold value.

The method can include averaging brightness information corresponding to pixels represented within the stored video data for a given individual NHA sensor, the averaging performed spatially over a pixel array of pre-defined dimensions, the pixel array defining a region that includes at least part of the given NHA sensor.

A system for calorimetry includes a test chamber having a sample provided therein, plural Nano Hole Array (NHA) sensors equally spaced apart and coupled to the test chamber, a heater in thermal contact with the test chamber, and a heater controller coupled to the heater, the heater controller programmed to control the heater to apply heat to the test chamber with the sample provided therein, the heat being applied at a known heat rate. The system further includes a camera or optical sensor configured to measure transmission of light through the NHA sensors to obtain a series of extraordinary optical transmission (EOT) measurements. An optics controller is coupled to the camera or optical sensor, the optics controller operatively coupled with the heater controller and programmed to initiate the measuring of the transmission of light in a manner in which the measuring is synchronized with the application of heat by the heater. The system includes a processor configured to calculate a calorimetry measurement as a function of the heat rate and the series of EOT measurements, the calorimetry measurement being indicative of energy released as a result of a change occurring among the first and second fluids in the test chamber during the application of heat to the test chamber.

The system can include a light source configured to irradiate the NHA sensors and the sample in the test chamber, wherein the light source is configured to irradiate the NHA sensors and the sample in the test chamber with incident light to measure the transmission of light.

The NHA sensors of the system can be integrated upon a substrate of a photonic sensor chip. Each NHA sensor can include an array of holes in an electrically conducting layer, the layer being proximate to and in thermal contact with the test chamber.

The test chamber can include a microchannel injection cell and the sample can include a first fluid and a second fluid, the microchannel injection cell including a first inlet whereby the first fluid is provided and a second inlet whereby the second fluid is provided.

The test chamber can include a co-flow reactor microchannel and the sample can include a first fluid and a second fluid, the system further including at least one pump and a pump controller, wherein the pump controller is programmed to control the at least one pump to flow the first fluid and the second fluid through the co-flow reactor microchannel, the first fluid flowing through a first inlet and the second fluid flowing through a second inlet.

The pump can be a syringe pump but other suitable pumps may be used. The syringe pump can be configured to drive the first fluid from a first syringe coupled to the first inlet and drive the second fluid from a second syringe coupled the second inlet.

The sample can be a solid sample, and the system can further include means of transferring the solid sample into the test chamber such that the sample is thereby provided therein. Example means for transferring a solid sample into the test chamber can include: placing the sample in the test chamber during assembly of the test chamber; using an auger to transfer the sample into the test chamber; dropping the sample into the test chamber; and dissolving the sample in a solvent, e.g., alcohol, transferring the dissolved sample into the chamber, and letting the solvent evaporate.

The system can further include a memory device, which can be coupled to, integrated with, or otherwise communicating with other components of the system.

The optics controller can be programmed to cause the camera or optical sensor to capture, and store in a memory device of the system, video data for a view of the NHA sensors. If the stored video data includes color video data, the processor can be configured to convert the color video data to black and white video data.

The processor can be further configured to identify bright spots, corresponding to individual NHA sensors, represented in the stored video data by comparing, with a brightness threshold value, brightness information corresponding to pixels represented within the stored video data; and determining locations within the view where the brightness information exceeds the threshold value.

The processor can be configured to average brightness information corresponding to pixels represented within the stored video data for a given individual NHA sensor, the averaging performed spatially over a pixel array of pre-defined dimensions, the pixel array defining a region that includes at least part of the given NHA sensor.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1A is top view of an example microchannel injection cell illustrating two inlets and one outlet, to be used in an embodiment.

FIG. 1B is a schematic illustration of a microchannel injection cell to be used in an embodiment. The microchannel injection cell is shown to contain a fluid A, while a fluid B is being injected into the microchannel injection cell.

FIG. 2A is a top view of an example co-flow reactor microchannel illustrating two inlets and an outlet, to be used in an embodiment.

FIG. 2B is a schematic illustration of a co-flow reactor microchannel to be used in an embodiment. The co-flow reactor microchannel is shown with fluids A and B flowing through the co-flow reactor microchannel.

FIG. 3 is a schematic diagram of a system for calorimetry according to an example embodiment.

FIG. 4 is a schematic diagram of a photonic sensor chip with integrated NHA sensors operatively coupled with a calorimetric test chamber according to an example embodiment.

FIG. 5 is a flow diagram showing an embodiment of an example method of calorimetry.

FIG. 6 is a diagram showing an expanded view of an example single NHA sensor, and an example video camera view illustrating a pixel representation of extraordinary optical transmission (EOT) through the sensor, according to an embodiment.

FIG. 7 is a view of an interface displaying pixel representations of a grid of NHA sensors according to an embodiment.

FIGS. 8A and 8B are plots of measured EOT vs. time for different NHA sensor resolutions for a test chamber into which a sample of ethanol is injected during testing, according to an embodiment.

FIGS. 9A and 9B are plots of EOT intensity vs. time and temperature vs. time, respectively, for an EOT vs. temperature calibration performed upon a test chamber according to an embodiment.

FIG. 9C is a plot of measured EOT vs. time and temperature vs. time for a test chamber into which a sample of ethanol is injected during testing, according to an embodiment. Measured EOT is plotted as EOT difference with respect to an initial EOT value.

FIG. 10A is a plot of measured EOT vs. time for individual NHA sensors in a test chamber into which a sample is injected during testing, according to an embodiment.

FIG. 10B is a plot of measured EOT vs. individual NHA sensors for different concentrations of samples, according to an embodiment.

### DETAILED DESCRIPTION

A description of example embodiments follows.

Embodiments provide a method and system for calorimetry, i.e., for performing calorimetric testing on one or more samples. Such samples may be in fluid form (e.g., a liquid solution, or a gas). Alternatively, or in addition, such samples may be in other forms, such as solid form (e.g., a powder, a crystal, an alloy, or any other solid form of matter known in the art. Such calorimetric testing may be performed to study different phenomena depending upon the nature or form of the one or more samples. Testing may be performed to determine an amount of energy released or absorbed in a process of a change undergone by the one or more samples, e.g., a chemical reaction; a denaturing of molecules; an unfolding of proteins; a phase change of matter such as melting, vaporization, solidification or freezing, condensing, etc.; and other types of changes in matter known in the art.

Devices and methods for ultra-sensitive temperature sensing and calorimetry have been described by Larson and Kowalski in International Patent Application Publication WO2008/088829, published Jul. 24, 2008, and corresponding U.S. Pat. No. 8,076,151 to Larson and Kowalski, issued Dec. 13, 2011, the teachings of which are incorporated herein by reference in their entirety.

A system and method for a microfluidic calorimeter have been described in U.S. Pat. No. 9,377,422 to Fiering et al., issued Jun. 28, 2016, the teachings of which are incorporated herein by reference in their entirety. Another system and method for a microfluidic calorimeter have been described in U.S. Pat. No. 10,677,661 to Modaresifar and Kowalski, issued Jun. 9, 2020, the teachings of which are incorporated herein by reference in their entirety.

In one embodiment, a photonic sensor is composed of a metallic film that is deposited on a dielectric substrate. A nanohole array (NHA) pattern is micro-manufactured using a nano, micro, or MEMS manufacturing process, or a combination of techniques thereof, in the metallic film. In an embodiment, the sensor includes a 10×10 array of apertures with a diameter of 150 nm and pitch size of 350 nm. These small holes can be made by using Focused Ion Beam or lithographic type processes on a 100 nm gold layer on a glass substrate. Suitable NHA sensor configurations and dimensions are described, for example, in U.S. Pat. Nos. 8,076,151; 9,377,422; and 10,677,661.

In one embodiment, a test chamber includes a gasket that is bounded by a photonic chip on one side and a transparent, rigid material on the opposite side. Means of injecting or flowing different solid or fluid samples into this chamber are manufactured in the gasket material. Two example configurations of a test chamber are considered: an injection chamber, and a co-flow channel for interacting two different fluid samples.

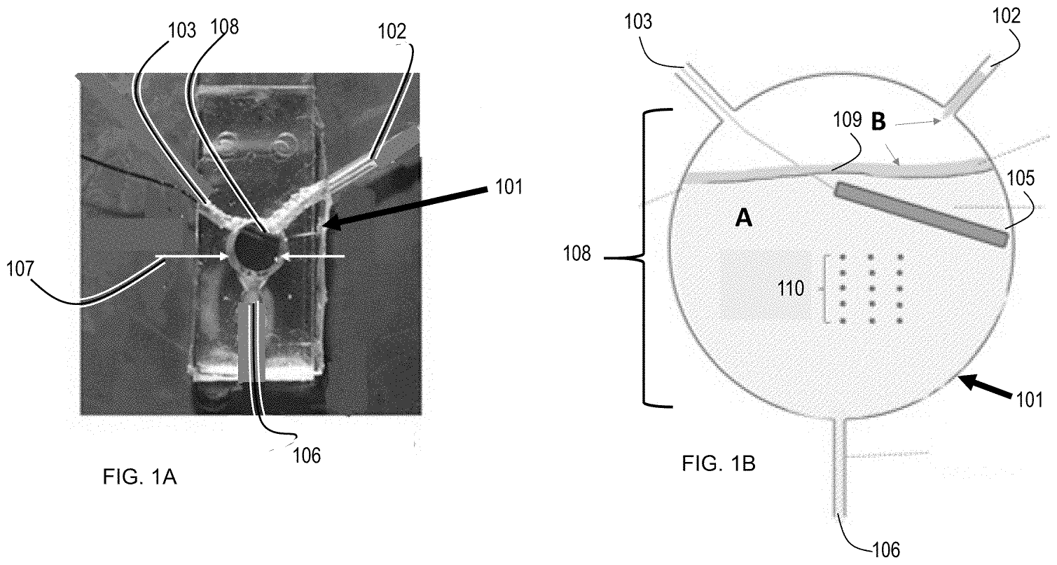

FIGS. 1A-1B depict a test chamber configured according to an example microchannel injection cell, to be used in an embodiment. In a typical microchannel injection cell 101, there is a sample inlet 102, air outlet 103, and sample outlet 106, as illustrated in FIG. 1A. After a fluid A is provided within a reaction zone 108 of the injection cell 101, a fluid B may be injected through inlet 102 and into the reaction zone 108, as illustrated in FIG. 1B. The fluids interact in reaction zone 108, e.g., by diffusion, chemical reaction, etc. The cell may be described by an overall dimension such as a diameter 107, which may be, for example, 6.4 mm or 6.8 mm.

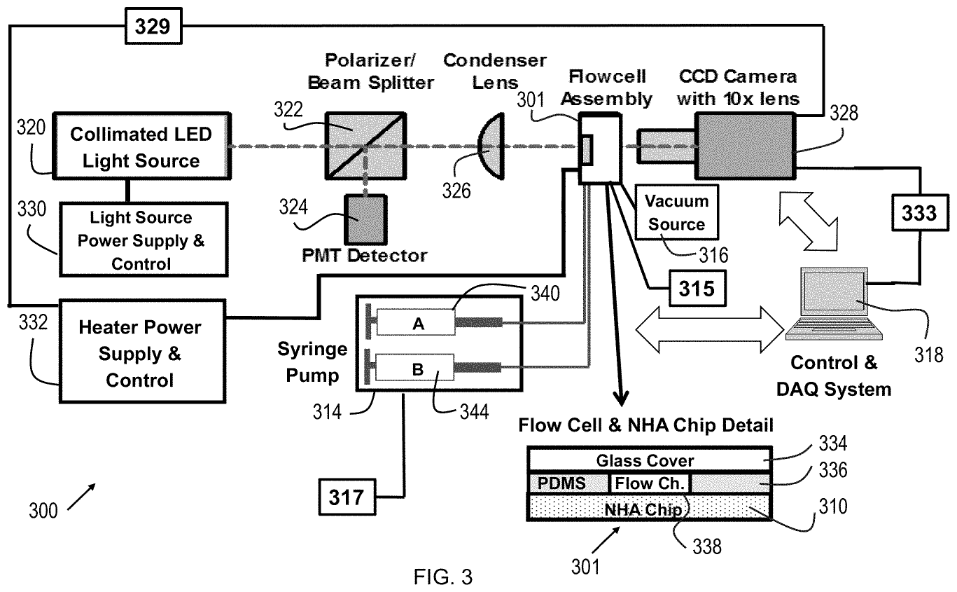

FIG. 1B is a schematic diagram of the microchannel injection cell test chamber 101 of FIG. 1A. An optional thermistor 105 can be seen to be electronically coupled with a non-pictured measurement device via a wire routed through air outlet 103. The interaction of fluids A and B is illustrated in FIG. 1B as an interface 109 between the fluids A and B. The fluids can be injected into inlet 103 using a syringe pump (see FIG. 3). A sensor field 110 includes multiple NHA sensors in a square or rectangular arrangement with equal spacing therebetween. The NHA sensors may be disposed upon a metallic film that is deposited on a dielectric substrate to form a photonic chip. As temperature in the test chamber varies, a dielectric constant of the sample varies accordingly, resulting in a variation in EOT incident upon a charge-coupled device (CCD) camera or other optical acquisition device (not shown in FIG. 1A or 1B) due to a phenomenon of photoplasmon resonance within the individual nanoholes included in a nanohole sensor.

Implementations of a microchannel injection cell such as cell 101 may be further described by a volume dimension, which may measure, for example, 155 μL. Injection volumes of, for example, 24-60 μL may be supported.

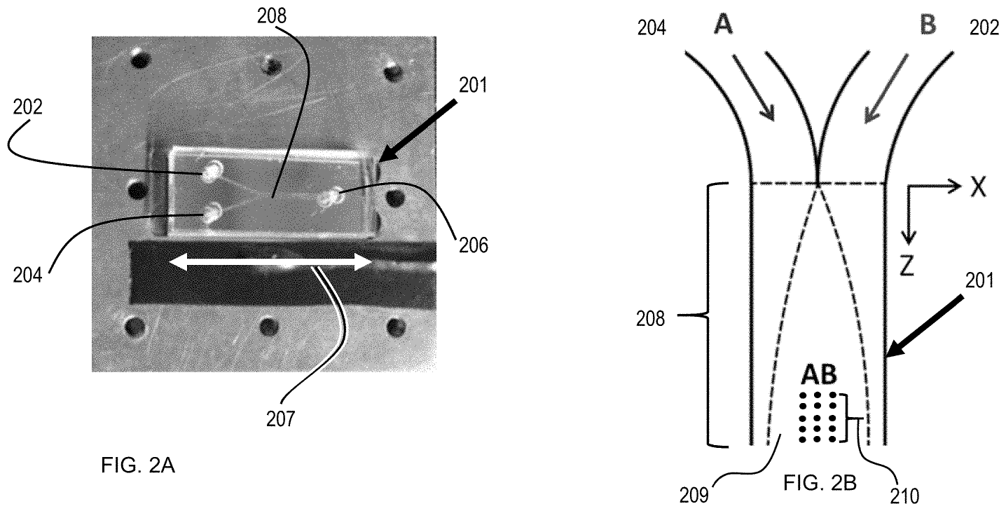

FIG. 2A depicts a test chamber configured according to an example co-flow microchannel having two inlets and one outlet, to be used in an embodiment. In a typical continuous co-flow microchannel 201, there are two inlets 202, 204, and one outlet 206, as illustrated in FIG. 2A. Two fluids (A, B) enter the channels via inlets 202, 204 and flow through microchannel 201. The fluids interact in reaction zone 208, e.g., by diffusion, chemical reaction, etc. The cell may be described by an overall dimension such as a length 207, which may be, for example, 20 mm. A sensor field 210 includes multiple NHA sensors in a square or rectangular arrangement with equal spacing therebetween. The NHA sensors may be similar to those described hereinabove with respect to FIG. 1B.

FIG. 2B is a schematic diagram of the continuous co-flow microchannel test chamber 201 of FIG. 2A. The interaction of fluids A and B is illustrated in FIG. 2B as a plume-shaped region 209. The fluids can be injected into inlets 202 and 204 using a syringe pump (see FIG. 3).

Implementations of a co-flow microchannel may confer various advantages upon experiments in which such a co-flow microchannel is employed, such as, for example, a very low Reynolds number; micro-level detection; use of small volumes of reactants; and use of incremental volumes in an axial flow direction, and in a direction perpendicular thereto, centered around an NHA sensor to provide information equivalent to that which may be provided by titrations in an Isothermal Titration calorimetry (ITC) process.

According to embodiments, a photonic chip, and a test chamber associated therewith, are placed into thermal contact (e.g., physical contact or proximal disposition) with a heater, which heater is turned on to change the temperature of a sample within the test chamber. The heater may be a thermoelectric heater, a resistive coil heater, or any other heating apparatus known in the art. A monochromatic, collimated beam of light may be passed through the test chamber and may be incident on the photonic chip. The incident light on the metallic film creates a surface plasmon resonance with the nanohole pattern that amplifies the transmitted light through the nanoholes. Such amplification produces extraordinary optical transmission (EOT) according to equations (1) through (3) below, wherein I is intensity transmitted through sensor, λₚ is the wavelength at peak intensity, h is the metallic film thickness, d is hole diameter, a₀ is the grid or matrix constant, y is an integer mode constant, and ε₁ and ε₂ are dielectric constants of the dielectric materials, i.e., of the sample and of the metallic film respectively. The EOT signal further depends upon variations of the dielectric constant of the sample of interest ε₁ with respect to temperature (T), concentration change ([C]), and pressure (P) in the sample, as shown in equation (3). Equation (3) specifically describes changes in the sample's dielectric constant, ε₁, with respect to temperature and concentration changes that alter the wavelength of peak intensity, λₚ, as shown in equation (2), which then alters the EOT as shown in equation (1).

$$\begin{matrix}EOT = I ( h , {λ}_{p} , d ) ∝ exp ( \frac{- 4 π h}{{λ}_{p}} \sqrt{{( \frac{{λ}_{p}}{1.7 d} )}^{2} - 1} ) & ( 1 ) \\ {λ}_{p} = \frac{{a}_{0}}{γ} ⌊ {( \frac{{ε}_{1} {ε}_{2}}{{ε}_{1} + {ε}_{2}} )}^{1 / 2} - sin θ ⌋ & ( 2 ) \\ d {ε}_{1} = \frac{\partial {ε}_{1}}{\partial T} {\vert}_{P , C} dT + \frac{\partial {ε}_{1}}{\partial P} {\vert}_{T , C} dP + \frac{\partial {ε}_{1}}{\partial [ C ]} {\vert}_{P , T} d [ C ] & ( 3 )\end{matrix}$$

The EOT thus varies in relation to the changes in the dielectric constants of the sample that are dependent on the temperature and concentration of the sample. The aforementioned U.S. Pat. No. 8,076,151 to Larson and Kowalski, specifically including columns 7 and 8 thereof, describes in additional detail the interactions between nanoholes of an arrangement of NHA sensors, and photons of light incident thereto, according to dielectric constants of materials of the arrangement of NHA sensors.

The changes in the temperature and concentration are directly related to the energy released from changes undergone by the sample, e.g., the reactions, phase changes, or similar physical phenomena occurring in the sample material. The aforementioned U.S. Pat. No. 8,076,151 to Larson and Kowalski, and U.S. Pat. No. 10,677,661 to Modaresifar and Kowalski provide equations and supporting descriptions to explain such relationships between energy released from the sample and changes in temperature and concentration thereof.

Benefits of using a photonic sensor include its small size and sensitive response to these changes. For water based materials, the sensitivity of the photonic sensor may be estimated to be, e.g., 5 picojoules, and a size of the sample can be as small as e.g., 25 nL, or smaller. The response speed of the photonic sensor approaches the speed of light. These size and response limits are orders of magnitudes, from a factor of 20 to 500, different from currently available calorimeters.

A variation of the example embodiment of the device would be to observe the EOT through the sample as it is heated to a maximum temperature. Such an EOT versus time response may follow an expected temperature versus time curve, until a change, e.g., an energy release or absorption process occurs. The expected temperature versus time curve may be obtained, for example, by measuring power dissipated by the heater as the heater functions to apply heat to the test chamber. The process of the change causes a significant variation in the observed EOT trend. This change, and knowledge of the heat flow through the sample, provide a means to measure a magnitude of the energy released by using the time of the event. Such knowledge of heat flow may be established via measurement thereof, derived from a signal controlling the heater, understood simply via pre-set specification, or by a combination of the aforementioned techniques, with or without other techniques presently known in the art. Once the change is identified, and once the EOT versus temperature relationship is calculated, other thermodynamic properties, such as entropy flow, Gibbs free energy, and equilibrium constant, may be determined.

An alternative to the above procedure uses an observed EOT trend and an expected EOT versus temperature relationship to determine an amount of energy released from the sample. The expected EOT versus temperature relationship may be obtained prior to testing the sample, by performing a calibration procedure. Similar relationships for determining the entropy flow, the Gibbs free energy, and the equilibrium constant may be used.

FIG. 3 is a schematic of an example embodiment of a system 300 for calorimetry. The system 300 includes a light source 320, test chamber 301, and CCD camera 328. The CCD camera 328 provides a measurement of a sensor field 310 as it changes during an experiment.

In the example illustrated in FIG. 3, the test chamber 301 is illustrated as a flowcell assembly that includes a co-flow reactor microchannel 338. A sample (not shown in FIG. 3) may be provided within the test chamber 301. The sensor field 310, including plural nanohole array (NHA) sensors, is coupled to the test chamber 301. Specifically, with regard to the embodiment of system 300, the sensor field 310 is implemented as a NHA sensor chip coupled to the co-flow reactor microchannel 338.

A pump 314 may be configured to drive fluid, e.g., a fluid sample, through the test chamber 301. Alternatively, the sample may be a solid sample, and the system 300 can further include means 315 of transferring the solid sample into the test chamber 301 such that the sample is thereby provided therein. Example means 315 for transferring a solid sample into the test chamber 301 can include: placing the sample in the test chamber 301 during assembly of the test chamber 301; using an auger to transfer the sample into the test chamber 301; dropping the sample into the test chamber 301; and dissolving the sample in a solvent, e.g., alcohol, transferring the dissolved sample into the chamber 301, and letting the solvent evaporate. The system 300 optionally includes a vacuum source 316 coupled to the test chamber 301, e.g., to the microchannel 338 thereof.

A control and data acquisition (DAQ) system 318 is coupled to the CCD camera 328. The CCD camera 328 may be coupled with a dedicated optics controller 329, or the control and DAQ system 318 may function as an optics controller to control the CCD camera 328. In combination with the sensor field 310 and the light source 320, the camera 328 allows detection of EOT through test chamber 301.

As shown in FIG. 3, the test chamber 301, which in the embodiment of system 300 includes the co-flow microchannel 338, has two inlets and an outlet. The pump 314 is a syringe pump configured to drive a first fluid (A) from a first syringe 340 that is coupled to a first of the inlets. A second syringe 344, which includes a second fluid (B), is coupled the second of the inlets. When flowing the first and second fluids through the test chamber 301, the pump 314 drives the second fluid (B) from the second syringe 344. In the example system configuration shown, the vacuum source 316 is coupled to the outlet of the test chamber 301. The vacuum source 316 can be a syringe pump. Suitable syringe pumps that can be used in embodiments of the invention include, for example, the PHD™ and PHD ULTRA™ syringe pumps (Harvard Apparatus, Holliston, Mass.). In alternative embodiments, the inlets and outlet may be respectively connected to means for inserting and removing a solid sample, such as, for example, an auger configured to carry the sample through the inlet and/or the outlet.

The system 300 includes a light source 320 configured to irradiate the sensor field 310 and fluid flowing through the co-flow reactor microchannel 338 of the test chamber 301. As illustrated in FIG. 3, the light source 320 is a collimated LED light source powered by a light source power supply 330. The light source power supply 330 may further include an illumination controller, i.e., light source power supply and control 330, that can be programmed to control the light source 320 to irradiate the sensor field 310 and fluid flowing through the test chamber 301 with incident light to measure the transmission of light. The illumination emanating from the light source 320 is sent through a polarizer/beam splitter 322, which sends part of the incident beam to a photomultiplier tube (PMT) detector 324 to monitor the intensity of the beam. The other part of the light beam is directed through condenser lens 326 onto the test chamber 301. A CCD camera 328, which includes a magnification lens (e.g., a 10× magnification lens), captures light transmitted through the test chamber 301. Any significant absorption in the sample fluid(s) can be determined by comparing the light intensity measured with the PMT detector 324 and the light intensity detected with the CCD camera 328.

As shown in FIG. 3, the sensor field 310 of the test chamber 301 includes plural NHA sensors. Each NHA sensor can include an array of holes in an electrically conducting layer that are proximate to and in thermal contact with the test chamber 301. A microchannel-type 338 test chamber 301 can be manufactured from polydimethylsiloxane (PDMS), a silicon-based organic polymer. The rheological (flow) properties of PDMS make it particular suitable for microfluidics applications. In the embodiment of system 300, a glass cover 334 is used to cover and protect the micro channel. The system 300 includes a heater controller, i.e., heater power supply and control 332, to monitor and control temperature of the test chamber 301 during EOT measurements. Temperature of the test chamber 301 may be so monitored and controlled while heat is applied to the test chamber 301 by a heater in thermal contact with the test chamber 301 with the sample provided within the test chamber 301, as during EOT measurements. Heat may be applied to the test chamber by the heater at a known heat rate. The known heat rate may refer at least to a measured value, level controlled by the heater controller, or a setting applied to the heater controller 332 or directly to the heater. In a typical arrangement of NHA sensors in the sensor field 310, the sensors are equally spaced apart. The NHA sensors can be arranged in parallel rows that are transverse to a direction of flow through the test chamber 301. An EOT difference can be calculated, for multiple NHA sensors and multiple rows of sensors, as a difference between a given measured EOT value and an initial EOT value.

A pump controller 317 can be programmed to control the pump 314 to flow the first fluid and a second fluid through the test chamber 301 such that a change, such as a reaction, occurs at least at a diffusion interface of the fluids, the first fluid flowing through a first of the inlets and the second fluid flowing through a second of the inlets. The aforementioned optics controller 329 (or the control and DAQ system 318 in functioning as an optics controller) may be programmed to measure transmission of light through the NHA sensors of the sensor field 310, while the first and second fluids flow through the test chamber 301, to obtain a series of EOT measurements. The system 300 also includes a processor configured to calculate a calorimetry measurement as function of the series EOT measurement and of the known rate at which heat was applied by the heater under control of the power supply and controller 332 thereof. The processor may be provided by the control and DAQ system 318. Such a calorimetry measurement may be indicative of energy released as a result of a change occurring among the first and second fluids in the test chamber 301 during the application of heat to the test chamber 301.

The system 300 can further include a memory device 333, which can be coupled to, integrated with, or otherwise communicating with other components of the system 300.

The optics controller 329 (or the control and DAQ system 318 in functioning as an optics controller) can be programmed to cause the camera or optical sensor 328 to capture, and store in the memory device 333, video data for a view of the sensor field 310 of NHA sensors. If the stored video data includes color video data, the processor can be configured to convert the color video data to black and white video data.

The processor can be further configured to identify bright spots, corresponding to individual NHA sensors of the sensor field 310, represented in the stored video data by comparing, with a brightness threshold value, brightness information corresponding to pixels represented within the stored video data; and determining locations within the view where the brightness information exceeds the threshold value.

The processor can be configured to average brightness information corresponding to pixels represented within the stored video data for a given individual NHA sensor of the sensor field 310, the averaging performed spatially over a pixel array of pre-defined dimensions, the pixel array defining a region that includes at least part of the given NHA sensor.

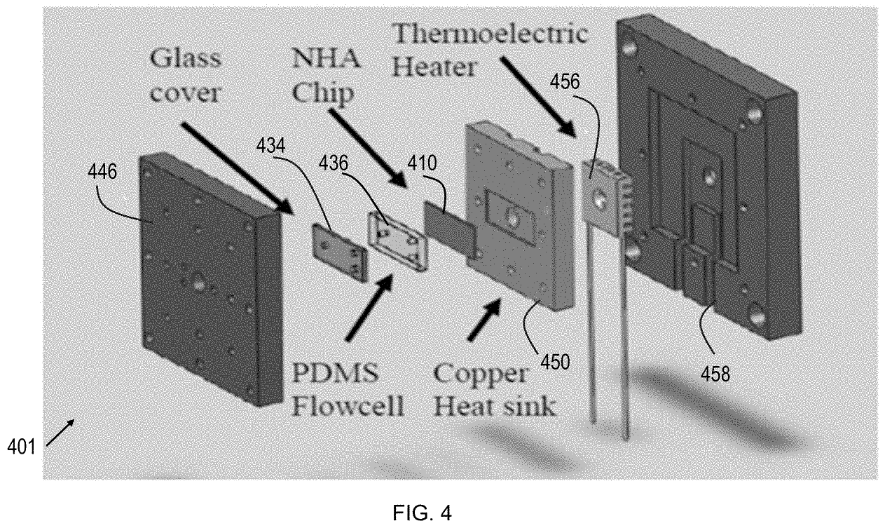

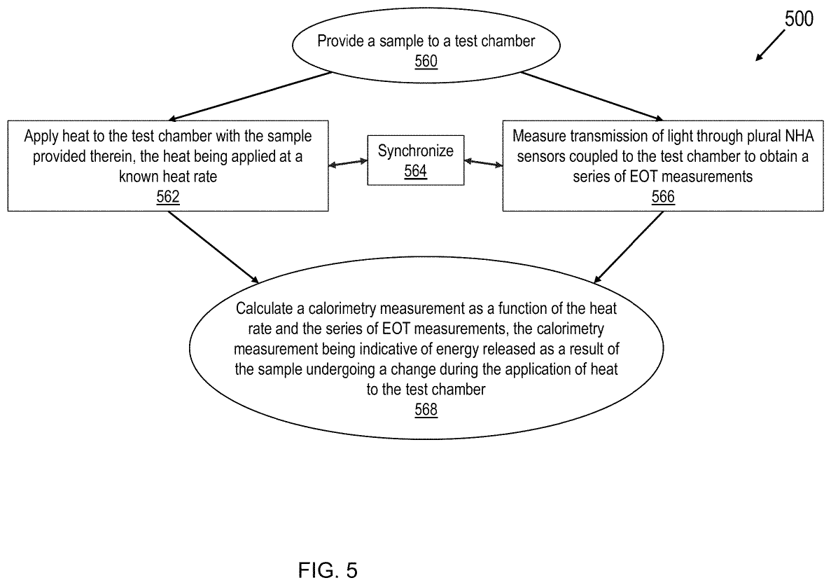

FIG. 4 is a schematic of an example test chamber 401 showing an assembly including a heater 456 and NHA chip 410. In a differential scanning microscope, the heater 456 has a set voltage applied to it to produce a transient change in the temperature of the PDMS flowcell 436. If there is an energy release, the observed change in temperature with time will deviate from that without an energy release. A change in the sample conditions will also create a change in the light transmission, i.e., the EOT.

In one example embodiment, a photonic chip 410 is manufactured by depositing a metallic film (e.g., gold) over a dielectric substrate (e.g., glass). A pattern of nanoholes, approximately 150 nm in diameters, placed at a pitch of 300 nm, are “drilled” into a film using a technique such as focused ion beam (FIB) or by lithography means. Over this photonic chip 410, a gasket of a flexible, nonreacting material is used to form the test chamber. In some embodiments, this may be a circular-formed chamber or a co-flow Y-pattern, for example. A rigid transparent slab may be placed over the gasket.

As shown in FIG. 4, a glass cover 434 may be disposed adjacently to the NHA chip. Additionally, a heat sink 450, e.g., of copper, may be employed within the test chamber 401. The entire assembly may be placed between two plastic plates 446, 458, and secured in four corners. The plastic plates 446, 458, the heat sink 450, and the heater 456 may incorporate holes, or other optical apertures such as transparent features, enabling light from the light source (e.g., light source 320 of FIG. 3) to be directed onto the sample within the test chamber 301, and onto the NHA sensors, e.g., of the photonic chip 410, and pass through plastic plates 446, 458, the heat sink 450, and the heater 456 to reach a CCD camera (not shown in FIG. 4, but an example CCD camera 328 is illustrated FIG. 3).

The plate 458 holding the chip 410 of the embodiment 400 of FIG. 4 may include a heater 456 that is set to a value to reach a temperature, for example, between 25-50 C. The sample is then exposed to a monochromatic collimated beam of light that is incident on it from the rigid transparent slab. A detector, CCD camera, or other means to view the transmitted light through the photonic chip is placed on the chip side of the assembly. In some embodiments, the detector records all transmitted light. A calibration procedure may be used to determine a relationship between the temperature and EOT values. The test chamber is filled with reactants, or other solid or liquid samples, or a flow through the test chamber is established. The heater is turned on, and the transmitted light through the chip is recorded as a function of time. The heater power through the chip sample may also be recorded as a function of time.

Collected data may be analyzed to determine the time and the EOT value at which an observable deviation from the expected monotonic EOT versus time relationship is observed. The EOT versus temperature calibration can be used to determine the energy released during the variation from the monotonic function for the expected value of EOT. An alternative approach monitors the heater power through the chip sample during the time of deviation. This information may then be used to determine the energy released and/or the temperature at which protein unfolding or molecular denaturing occurs. The observed deviation can also be used to monitor deviations in quality of a produced product.

In some embodiments, a challenge of NHA sensor array positioning due to slight movements, such as those resulting from thermal vibrations, during EOT measurements taken while heat is being applied to the test chamber, is addressed by performance of a field capture process as described as follows. In the field capture process, video data for a view of the NHA sensors is captured and stored in memory. As mentioned above, in some embodiments, the view includes every NHA sensor array on the photonic chip. Some embodiments are configured to process black-and-white video data; as such, embodiments of the field capture process include converting any color video data to black and white video data for processing. Such processing subsequently begins by identifying bright spots, corresponding to individual NHA sensors, represented in the stored video data. Bright spots may be identified by examining brightness information corresponding to pixels represented within the stored video data, and comparing the brightness information with a pre-determined or pre-set brightness threshold value. Such identification of bright spots may be performed using a publicly-available data analysis software application such as MATLAB, among other applications. In some embodiments, x-y coordinates of individual pixels, or groups thereof, corresponding with the identified bright spots are defined relative to an origin. Such x-y coordinates may be stored in memory for later reference.

Embodiments of the field capture process continue by referring to the defined x-y coordinates of identified bright spots, and performing a pixel averaging procedure incorporating brightness data corresponding to neighboring pixels of the respective pixels corresponding to the identified bright spots. For a given bright spot, such neighboring pixels, along with the pixel(s) corresponding with the identified bright spots, together represent video data for a given NHA sensor. The pixel averaging procedure for a given bright spot may be a spatial average incorporating brightness data corresponding to pixels comprising a pixel array of pre-defined dimensions. Such a pixel array may define a region that includes at least a part of the given NHA sensor, but, preferably, the whole NHA sensor. The pre-defined dimensions of the pixel array may, for example, be any odd number of pixels in x- and y-directions, such as 3, 5, 7, 9, or 11 pixels, etc. The number of pixels in the x-direction may or may not be the same as the number of pixels in the y-direction. In a best-mode implementation of the pixel averaging procedure, pre-defined dimensions of 13×13 pixels, respectively in the x- and y-directions, were found to produce an array of pixel data with a lowest level of observed measurement noise. Pre-defined dimensions for such a best mode may vary depending upon the specific CCD camera used to capture the video data, and may be determined empirically therefrom.

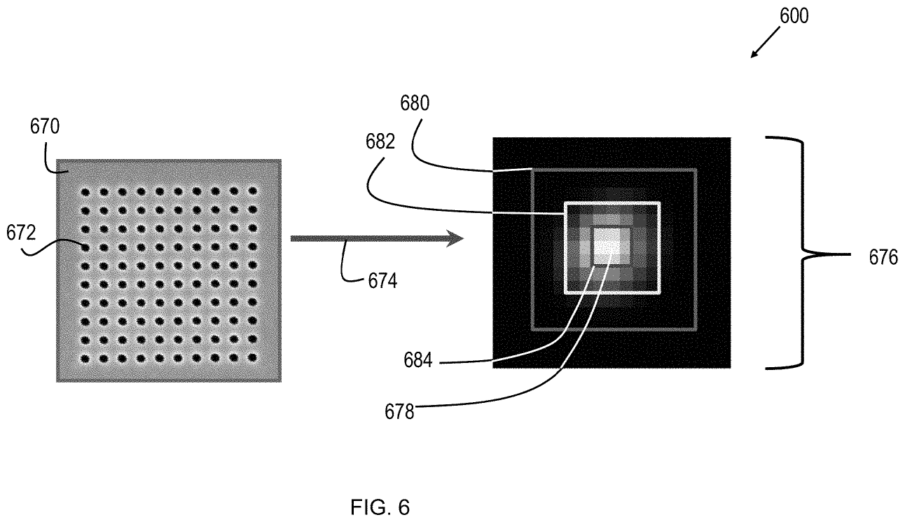

FIG. 6 is a diagram 600 illustrating the pixel averaging procedure according to embodiments. The diagram 600 includes an expanded, i.e., magnified view 670 of a single NHA sensor comprising an array of individual nanoholes 672. Multiple such sensors may be arranged within a test chamber, e.g., the test chamber 301 of FIG. 3. Upon acquisition of video data 674 during an EOT measurement, black-and-white brightness data corresponding to a given NHA sensor 676 is produced. Pixels further from a given bright spot 678, with brightness data indicating a darker appearance relative to the given bright spot 678 and thus less EOT versus the center of the sensor, still contain valuable information to be incorporated by the pixel averaging procedure, despite the low intensity of illumination of such pixels. As such, different dimensions of a pixel array, substantially centered upon the given bright spot, provide different signal-to-noise ratios for brightness data averaged spatially over the pixel array. In the diagram 600, pixel arrays of different dimensions are shown superimposed over a representation of video data for the given NHA sensor 676, including a 13×13 array 680, a 7×7 array 682, and a 3×3 array 684.

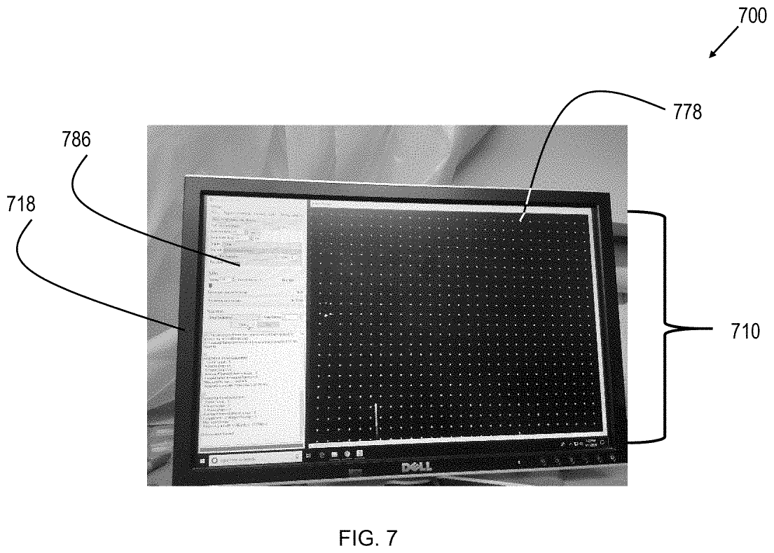

FIG. 7 is a view 700 of a monitor of a control and DAQ system 718 displaying, in an interface 786, an NHA sensor array 710 made up of bright spots 778 corresponding to individual NHA sensors 670. Each NHA sensor 670, in turn, may be made up of a number of individual nanoholes 672 as seen in FIG. 6.

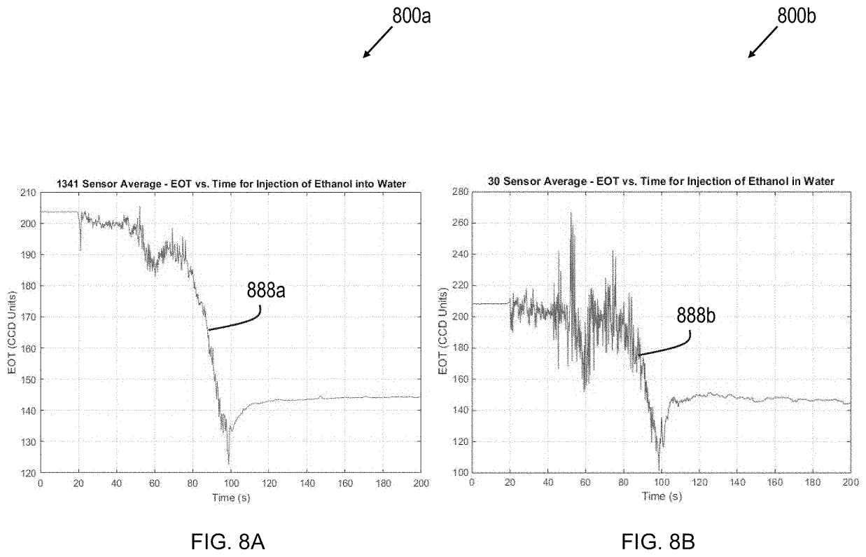

FIGS. 8A and 8B are plots 800a and 800b of measured EOT versus time, acquired according to embodiments. Example implementations of a sensor averaging procedure are reflected in FIGS. 8A and 8B, with EOT versus time data averaged over 1341 sensors (888a) shown in FIG. 8A, and EOT versus time data averaged over just 30 sensors (888b) shown in FIG. 8B. The curve for 1341 averages (888a) is noticeably less noisy than the curve for 30 averages (888b). Each curve 888a, 888b illustrates an EOT measurement over time, synchronized to an application of heat to a water-containing test chamber wherein an amount of ethanol is injected into the test chamber at a time of 20 seconds. From the time of injection, an energy release event is recorded, with the respective EOT versus time curves dropping off at the time of injection, and again achieving a steady-state at around 120 seconds.

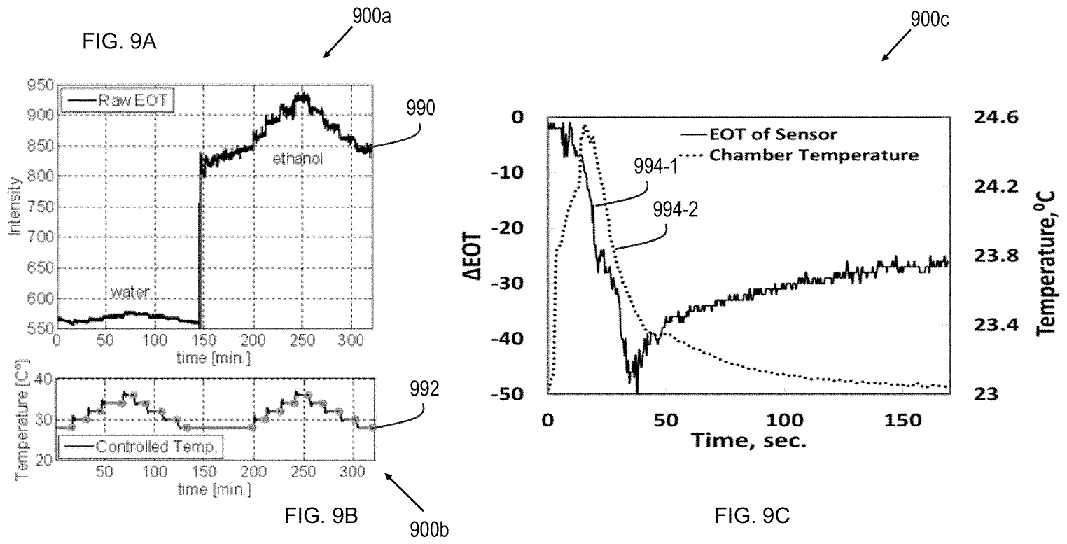

FIG. 9A is a plot 900a of intensity, i.e., EOT intensity (or, simply, EOT), versus time in a temperature calibration used in embodiments. FIG. 9B is a plot 900b showing the corresponding temperature versus time curve for the heat applied to a test chamber concurrently with taking the EOT measurements of FIG. 9A. A pair of step-up and step-down patterns 992 are displayed in the plot 900b. One pattern of the pair describes heat levels applied to a water-filled test chamber, while the other pattern of the pair describes similar heat levels applied to an ethanol-filled test chamber. Such knowledge of EOT versus temperature for pure substances within the test chamber may be taken into account during EOT measurements of actual samples.

The temperature calibration may be performed as follows. First, a slope may be calculated for the region EOT intensity vs. time plot 900a of FIG. 9A corresponding to the water-filled test chamber, and likewise for the region corresponding to the ethanol-filled test chamber, and a ratio of the aforementioned slopes may then be computed, all according to equation (4) below. The slopes may be calculated empirically from a pair of mutually representative data points of the plot 900a from the appropriate region. The plots may be judged to be mutually representative by eye, as appearing to approximate the dynamic slope of the plot by the singular slope therebetween, or by other means. Next, with equation (5) for the dielectric constant of the sensors of the nanohole arrays, and with respective compressibilities of water (6a) and ethanol (6b) known, derivatives of the dielectric constant with respect to temperature of the test chamber, respectively for the water-filled (7a) and ethanol-filled (7b) test chambers, may be calculated. To be clear, the water-filled and ethanol-filled test chambers may be the same test chamber examined for different time intervals, wherein the contents of the test chamber are different, namely, water for one time interval, and ethanol for another time interval. A ratio of the derivatives may then be calculated according to equation (8) to establish an expected monotonic EOT vs. temperature relationship. A difference between the empirically obtained ratio and the expected ratio may then be calculated according to equation (9), which may be subtracted from a series of measured EOT data for a test chamber into which a sample has been provided during a subsequent experiment. Numerical values used in equations (4) through (9) below are exemplary values taken from the plots 900a and 900b, respectively of FIGS. 9A and 9B.

$$\begin{matrix}\frac{{slope}_{ethanol}}{{slope}_{water}} = \frac{( 928 - 848 ) CCD \text{Units/} ( 36 - 28 ) ° \text{C.}}{( 579 - 558 ) CCD \text{Units/} ( 36 - 28 ) ° \text{C.}} = 3.81 & ( 4 ) \\ {ε}_{1} = [ \frac{1 + 2 {C}_{0} {ρ}_{0} Φ}{1 - {C}_{0} {ρ}_{0} Φ} ] & ( 5 ) \\ {β}_{water} = 207 \cdot {10}^{- 6} \frac{1}{° \text{C.}} & ( 6 a ) \\ {β}_{ethanol} = 750 \cdot {10}^{- 6} \frac{1}{° \text{C.}} & ( 6 b ) \\ \frac{d {ε}_{1}}{dT} {\vert}_{ethanol} = 7.403 \cdot {10}^{- 4} \frac{1}{° \text{C.}} & ( 7 a ) \\ \frac{d {ε}_{1}}{dT} {\vert}_{water} = 2.03 \cdot {10}^{- 4} \frac{1}{° \text{C.}} & ( 7 b ) \\ \frac{d {ε}_{1}}{dT} {\vert}_{ethanol} / \frac{d {ε}_{1}}{dT} {\vert}_{water} = 3.647 & ( 8 ) \\ Difference = \frac{\text{Eq. (4)} - \text{Eq. (8)}}{\text{Eq. (8)}} = \frac{3.81 - 3.647}{3.647} = 4.47 \% & ( 9 )\end{matrix}$$

FIG. 9C is a plot 900c of EOT versus time and test chamber temperature versus time for a single NHA sensor in the test chamber, obtained in an embodiment. EOT measurements are thus synchronized with a known heat rate as heat is applied to the sample-populated test chamber. EOT in FIG. 9C is indicated as a differential measurement ΔEOT, taken as a difference with respect to a starting EOT value. Any of the EOT measurements referred to herein may be so implemented. EOT curve 994-1 is seen in FIG. 9C to drop off immediately as heat begins to be applied as indicated by temperature curve 994-2. As the sample in the test chamber undergoes a change in response to the applied heat, the EOT is seen to reach a minimum value before gradually increasing again, as the chamber temperature due to applied heat peaks and subsequently decays.

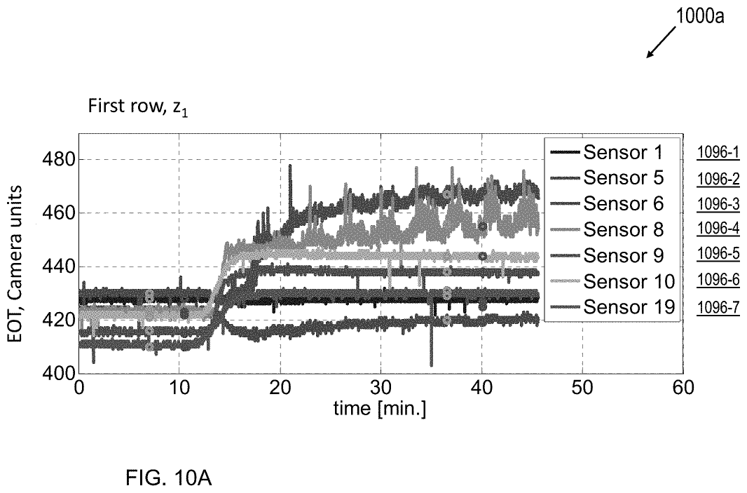

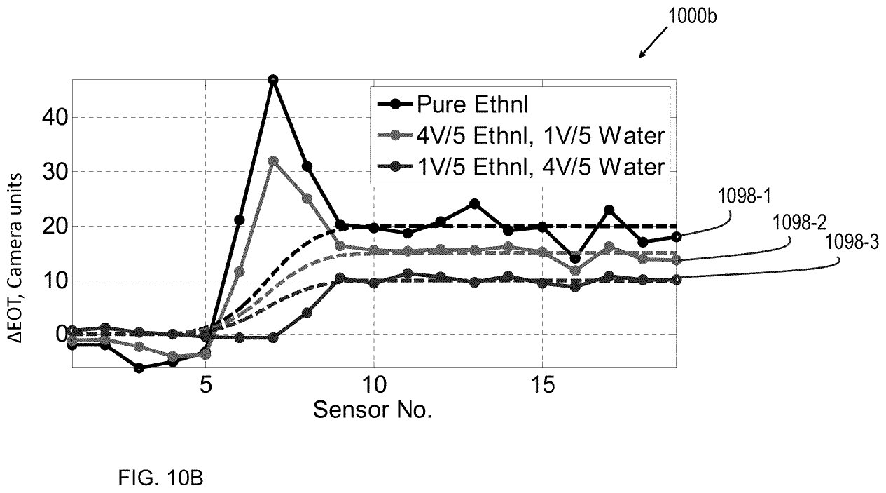

FIG. 10A is a plot 1000a of EOT versus time for seven different individual NHA sensors in the test chamber, obtained in an embodiment. EOT curves are shown for the individual sensors, including a Sensor 1 EOT curve 1096-1, a Sensor 5 EOT curve 1096-2, a Sensor 6 EOT curve 1096-3, a Sensor 8 EOT curve 1096-4, a Sensor 9 EOT curve 1096-5, a Sensor 10 EOT curve 1096-6, and a Sensor 19 EOT curve 1096-7. Such EOT curves for different individual NHA sensors are indicative of different amounts of light being transmitted through nanoholes of each NHA sensor because of changes in the dielectric constant (of the sample) caused by the temperature changes related to the reactions.

FIG. 10B is a plot 1000b of EOT versus individual NHA sensor for three different concentrations of a pair of sample fluids within a test chamber, obtained in an embodiment. EOT curves are shown for the different concentrations, including a pure ethanol EOT curve 1098-1, an EOT curve for 80% ethanol-water solution 1098-2, and an EOT curve for a 20% ethanol-water solution 1098-3. Such EOT curves for different concentrations of the pair of sample fluids are indicative of different amounts of energy released upon heating of the samples, with pure ethanol releasing the most energy, and the 20% solution releasing the least energy, as a skilled person would expect. The plot for the pure ethanol solution 1098-1 and the plot for the 80% solution indicate that a bulk of the released energy was detected by sensor numbers 6, 7, and 8.

Some example features of embodiments are as follows. Embodiments may be configured to function with no direct wire connections between the sample and the sensor. Some embodiments feature a sensor of a sufficiently small size to allow a small sample volume to be used. Such a size may be, for example, 3 microns square. Such a small size, along with sensitivity of embodiments allow for slow-reacting compounds, such as sugar proteins, to be investigated directly without additional chemical amplification steps. Such a small size may also reduce compound consumption and reduce cost of, and time required for, a given test. Such a small size, along with the photonic characteristic of the sensor, allows the device to be multiplexed on a single chip for high throughput applications. In some embodiments, an order of reduction in test time and a 20-500 times reduction in compound consumed may be realized.

Various advantages of performing calorimetric testing according to embodiments include improved speed of testing, capability for multiplexing and high throughput screening, enabling compound reduction, providing increased sensitivity, e.g., to 5 pJ; and enabling the field capture data acquisition and post processing procedure described hereinabove. For example, the small size, reduced compound, and ability for multiplexing in a high throughput implementation all serve to facilitate incorporation with the automated systems used in pharmaceutical laboratories or in the product line of drugs. Additionally, because a device that employs embodiments of the invention is faster than existing devices and, in some configurations, reduces or eliminates cleaning of the instrument, testing time is reduced. Advantages further include a low initial cost of some embodiments of the device, including a disposable test chamber, relative to commercially available calorimeters.

Various example applications of embodiments include drug discovery; quality control monitoring; genome investigation; studying energy releases associated with protein unfolding; studying energy releases associated with changes in materials, such as phase changes, structural changes and magnetic changes; and various applications in the pharmaceutical and biotechnology areas, among others.

Additional uses of embodiments include testing of biohazardous materials, testing of explosive materials, and integration into material testing related to phase changes of materials. The small size of embodiments, and ability of embodiments to be monitored remotely, improve safety of testing the above types of materials.

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. A method for calorimetry, the method comprising:
a) providing a sample to a test chamber;
b) applying heat to the test chamber with the sample provided therein, the heat being applied at a known heat rate;
c) in a synchronized manner with respect to applying heat to the test chamber, measuring transmission of light through plural Nano Hole Array (NHA) sensors coupled to the test chamber to obtain a series of extraordinary optical transmission (EOT) measurements; and
d) calculating a calorimetry measurement as a function of the heat rate and the series of EOT measurements, the calorimetry measurement being indicative of energy released as a result of the sample undergoing a change during the application of heat to the test chamber.

2. The method of claim 1, wherein calculating the calorimetric measurement includes calculating an EOT difference for the NHA sensors over an interval of time.

3. The method of claim 1, wherein calculating the calorimetric measurement includes averaging plural series of EOT measurements to obtain a series of averaged EOT values.

4. The method of claim 1, wherein the sample includes at least two samples.

5. The method of claim 1, further including performing an EOT vs. temperature calibration, and wherein calculating the calorimetric measurement includes determining a deviation from an expected EOT vs. time relationship, and determining the energy released during the change that the sample undergoes based on (i) the deviation and (ii) a corresponding result of the EOT vs. temperature calibration.

6. The method of claim 1, further including:
a) performing an EOT vs. temperature calibration; and
b) monitoring power dissipated in applying the heat; and
wherein calculating the calorimetric measurement includes determining the energy released during the change that the sample undergoes based on (i) the power dissipated in applying the heat and (ii) a corresponding result of the EOT vs. temperature calibration.

7. The method of claim 1, wherein measuring transmission of light includes irradiating the NHA sensors and the sample in the test chamber with incident light.

8. The method of claim 1, wherein the NHA sensors are integrated upon a substrate of a photonic sensor chip, and wherein each NHA sensor includes an array of holes in an electrically conducting layer, the layer being proximate to and in thermal contact with the test chamber.

9. The method of claim 1, wherein the test chamber is a microchannel injection cell and the sample includes a first fluid and a second fluid, wherein providing the sample includes injecting the second fluid into the microchannel injection cell after providing the first fluid to the microchannel injection cell.

10. The method of claim 1, wherein the test chamber is a co-flow reactor microchannel and the sample comprises a first fluid and a second fluid, the method further comprising:
a) flowing the first fluid and the second fluid through the co-flow reactor microchannel, the first fluid flowing through a first inlet and the second fluid flowing through a second inlet; and
b) while flowing the first and second fluids and applying heat to the co-flow reactor microchannel, measuring transmission of light through the NHA sensors to obtain the series of EOT measurements.

11. The method of claim 10, wherein flowing the first and seconds fluids includes using a syringe pump to drive the first fluid from a first syringe coupled to the first inlet and drive the second fluid from a second syringe coupled the second inlet.

12. The method of claim 1, wherein the measuring transmission of light includes:
a) capturing, and storing in memory, video data for a view of the NHA sensors;
b) if the stored video data includes color video data, converting the color video data to black and white video data;
c) identifying bright spots, corresponding to individual NHA sensors, represented in the stored video data by
i) comparing, with a brightness threshold value, brightness information corresponding to pixels represented within the stored video data; and
ii) determining locations within the view where the brightness information exceeds the threshold value; and
d) averaging brightness information corresponding to pixels represented within the stored video data for a given individual NHA sensor, the averaging performed spatially over a pixel array of pre-defined dimensions, the pixel array defining a region that includes at least part of the given NHA sensor.

13. A system for calorimetry, the system comprising:
a) a test chamber having a sample provided therein;
b) plural Nano Hole Array (NHA) sensors equally spaced apart and coupled to the test chamber;
c) a heater in thermal contact with the test chamber; and
d) a heater controller coupled to the heater, the heater controller programmed to control the heater to apply heat to the test chamber with the sample provided therein, the heat being applied at a known heat rate;
e) a camera or optical sensor configured to measure transmission of light through the NHA sensors to obtain a series of extraordinary optical transmission (EOT) measurements;
f) an optics controller coupled to the camera or optical sensor, the optics controller operatively coupled with the heater controller and programmed to initiate the measuring of the transmission of light in a manner in which the measuring is synchronized with the application of heat by the heater; and
g) a processor configured to calculate a calorimetry measurement as a function of the heat rate and the series of EOT measurements, the calorimetry measurement being indicative of energy released as a result of a change occurring among the first and second fluids in the test chamber during the application of heat to the test chamber.

14. The system of claim 13, further including a light source configured to irradiate the NHA sensors and the sample in the test chamber, wherein the light source is configured to irradiate the NHA sensors and the sample in the test chamber with incident light to measure the transmission of light.

15. The system of claim 13, wherein the NHA sensors are integrated upon a substrate of a photonic sensor chip, and wherein each NHA sensor includes an array of holes in an electrically conducting layer, the layer being proximate to and in thermal contact with the test chamber.

16. The system of claim 13, wherein the test chamber is a microchannel injection cell and the sample includes a first fluid and a second fluid, the microchannel injection cell including a first inlet whereby the first fluid is provided and a second inlet whereby the second fluid is provided.

17. The system of claim 13, wherein the test chamber is a co-flow reactor microchannel and the sample includes a first fluid and a second fluid, the system further including at least one pump and a pump controller, wherein the pump controller is programmed to control the at least one pump to flow the first fluid and the second fluid through the co-flow reactor microchannel, the first fluid flowing through a first inlet and the second fluid flowing through a second inlet.

18. The system of claim 17, wherein the pump is a syringe pump configured to drive the first fluid from a first syringe coupled to the first inlet and drive the second fluid from a second syringe coupled the second inlet.

19. The system of claim 13, wherein the sample is a solid sample, the system further including means of transferring the solid sample into the test chamber such that the sample is thereby provided therein.

20. The system of claim 14, further including a memory device, and wherein:
a) the optics controller is programmed to cause the camera or optical sensor to capture, and store in the memory device, video data for a view of the NHA sensors;
b) if the stored video data includes color video data, the processor is configured to convert the color video data to black and white video data;
c) the processor is further configured to identify bright spots, corresponding to individual NHA sensors, represented in the stored video data by
i) comparing, with a brightness threshold value, brightness information corresponding to pixels represented within the stored video data; and
ii) determining locations within the view where the brightness information exceeds the threshold value; and
d) the processor is further configured to average brightness information corresponding to pixels represented within the stored video data for a given individual NHA sensor, the averaging performed spatially over a pixel array of pre-defined dimensions, the pixel array defining a region that includes at least part of the given NHA sensor.
